(19) United States
(12) Patent Application Publication
(10) Pub. No.: US 2024/0419011 A1
(43) Pub. Date: Dec. 19, 2024

(54) Optical Lens system including a Variable Reflectivity beam splitter

(71) Applicant: John Le, Woodbury, MN (US)

(72) Inventor: John Le, Woodbury, MN (US)

(21) Appl. No.: 18/335,033

(22) Filed: Jun. 14, 2023

(51) Int. Cl. G02B 27/14; G02B 27/28; G06F 1/16

(52) U.S. Cl. CPC G02B 27/144; G02B 27/286; G06F 1/163

(57) ABSTRACT

Aspects of the disclosure provide an optical system. The lens system includes a first lens, a second lens, and an optical cavity. The optical cavity comprises a beam splitter, a reflective polarizer, a waveplate, and at least one lens from the said lens, wherein the said beam splitter, the reflective polarizer, and waveplate are disposed on and substantially conforming to the surfaces of the said lens. In a embodiment, the said beam splitter includes a first field region having a first reflectance, and a second field region having a second reflectance and wherein the said second reflectance is at least ten percent higher than the said first reflectance. In an another embodiment, the said beam splitter includes a first area having a first transmittance, and a second area having a second transmittance and wherein the said first transmittance is at least ten percent higher than the said second transmittance.

### TECHNICAL FIELD

The present disclosure relates to near eye display technology.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Near eye display (NED) devices are being developed to provide an improved user experience in fields such as augmented reality (AR) and virtual reality (VR). The NED devices can include various wearable devices, such as a head mounted display (HMD) device, smart glasses, and the like. In an example, an HMD device includes a relatively small display device and optics that can create a virtual image in the field of view of one or both eyes. To the eye, the virtual image appears at a distance and appears much larger than the relatively small display device.

### SUMMARY

Aspects of the disclosure provide an optical system. The optical system includes the one or more lenses. The first lens includes a first optically transparent member having a first surface and a second surface. The optical system includes a reflective polarizer configured to pass the light beams having a first polarization state and reflect the light beams having a second polarization state that is orthogonal to the first polarization state. The optical system includes a beam splitter configured to partially transmit and partially reflect the light beams incident onto the beam splitter, the said beam splitter includes a first field region having a first reflectance, and a second field region having a second reflectance wherein the said second reflectance is at least ten percent higher than the said first reflectance.

In an embodiment, an optical cavity including the one or more lenses is formed between the beam splitter and the reflective polarizer, and the light beam passes the optical cavity three times before reaching a viewing position.

In an embodiment, the optical system includes a quarter waveplate (QWP) that is positioned between the beam splitter and the reflective polarizer.

In an example, the optical system further includes a first lens, the one or more lenses includes a second lens, and a display device, and the lens are positioned between the display device and a viewing position. The first lens and the second lens can be separated by a gap.

In an example, the beam splitter is positioned between the second lens or the second lens and the display device, the reflective polarizer is positioned between a viewing position and the first lens or the second lens, and the QWP is positioned between the beam splitter and the reflective polarizer.

In an example, the first lens surface is an aspheric surface.

In an example, the optical system includes a second lens including a second optically transparent member having a third surface and a fourth surface. The second lens can be a plano-spheric lens.

In an example, the first polarization state is a first linear polarization state, and the second polarization state is a second linear polarization state.

In an embodiment, an optical system can include the lens system, a beam splitter configured to partially transmit and partially reflect light beams from a display device, a reflective polarizer configured to pass through light having a first linear polarization state and reflect light having a second linear polarization state that is orthogonal to the first linear polarization state, and a quarter waveplate (QWP) that is positioned between the beam splitter and the reflective polarizer.

In an example, the optical system includes the display device. A pixel array in the display device is configured to generate light beams. A polarization state of the light beams can be a first circular polarization state.

In an example, the first and second optically transparent member are made of cyclic olefin co-polymer (COC). A thickness of the reflective polarizer can be from 30 to 200 microns.

Aspects of the disclosure provide a fabrication method. The fabrication method includes positioning a film including a first material on a first mold and filling a mold cavity between a first mold surface of the first mold and a second mold surface of a second mold with a second material such that the first material conforms to a first surface profile of the first mold surface. A first lens can be formed with the solidified second material. A first surface of the first lens can be attached to the film.

### BRIEF DESCRIPTION OF THE DRAWINGS

Further features, the nature, and various advantages of the disclosed subject matter will be more apparent from the following detailed description and the accompanying drawings in which:

FIG. 1 shows a schematic of display system in a side view according to some embodiments of the disclosure.

FIG. 2 shows examples of eye rotations and head rotations.

FIG. 3 shows a relationship between visual acuity and eccentricity.

FIG. 4A shows an example of a display system in a side view according to some embodiments of the disclosure.

FIG. 4B shows an example of a beam splitter design used in the example of the display system shown in FIG. 4A according to some embodiments of the disclosure.

FIG. 4C shows an MTF of an example of a display system shown in FIG. 4A according to some embodiments of the disclosure.

FIG. 4D shows an MTF of an example of a display system shown in FIG. 4A according to some embodiments of the disclosure.

FIG. 5A shows an example of a display system in a side view according to some embodiments of the disclosure.

FIG. 5B shows an example of a beam splitter design used in the example of the display system shown in FIG. 5A according to some embodiments of the disclosure.

FIG. 5C shows an MTF of an example of a display system shown in FIG. 5A according to some embodiments of the disclosure.

FIG. 5D shows an MTF of an example of a display system shown in FIG. 5A according to some embodiments of the disclosure.

### DETAILED DESCRIPTION OF EMBODIMENTS

A display system can include a lens system that directs light beams from a display device or a real object to a light receiver. In an example, the lens system and the display device can be configured to be positioned within a distance threshold (e.g., 35 mm) of an eye of a user, and the display system can be referred to as a near eye display (NED) system. For example, the display system is a head mounted display (HMD) system worn by a user.

The lens system can include refractive optical element(s) (e.g., a lens) that refract light. For example, light is refracted at surface(s) of a lens. In various embodiments, a refractive power or an optical power (e.g., indicated by a focal length) of a lens can be determined by shape(s) of respective surface(s) (or surface curvature(s)) of the lens.

Surfaces of lenses of the lens system can have any suitable shapes, such as planar shape(s) parallel to an XY plane, spheric shape(s) with any suitable radius of curvature (e.g., a continuous (or grooved) spheric shape or a discontinuous (or grooved) spheric shape with a Fresnel structure), aspheric shape(s) (e.g., a smooth aspheric shape or a grooved aspheric shape with a Fresnel structure), or other shape(s). As described above, each shape can be a smooth shape or a grooved shape (e.g., a shape including a Fresnel structure).

In addition to lenses, the optical system can include thin-film optical component(s). A thin-film optical component can include one or more layers of optical films. A thickness of a thin-film optical component can be thin, for example, less than a thickness threshold (e.g., 200 microns). Thin-film optical components in the optical system can include a reflective polarizer, a beam splitter (BS), a waveplate (e.g., a quarter waveplate (QWP)), and the like. A thin-film optical component (e.g., a reflective polarizer, a BS, a QWP) can be disposed on a surface of a lens, and can conform to a surface profile (or a shape) of the surface of the lens.

In an embodiment, a reflective polarizer is disposed on a surface of a lens, and an optical component including the lens and the reflective polarizer is referred to as a reflective polarizer lens (or an RP lens). The reflective polarizer lens can be fabricated using a co-molding process (or a co-mold process). In the co-mold process, an optical film including a first material (or an RP material) used to fabricate the reflective polarizer can be positioned on a first mold. A mold cavity between a first mold surface of the first mold and a second mold surface of a second mold can be filled with a second material such that the first material of the optical film conforms to a first surface profile of the first mold surface. Thus, the reflective polarizer and the lens can be formed based on the first material and the second material, respectively, for example, simultaneously in the co-mold process.

A shape of the surface of the lens can be represented by a sagitta (or a sag). A sagitta can indicate material removed to yield the surface of the lens. In an example, a sagitta is a displacement along an optic axis of the surface from a vertex (e.g., an intersection of the surface and the optical axis). The shape of the surface of the lens can be represented by a maximum absolute sagitta, a maximum sagitta difference, an average absolute sagitta of respective locations on the surface of the lens, or the like. In an embodiment, a sagitta (e.g., a maximum absolute sagitta or an average absolute sagitta) increases with a curvature of the surface.

In some examples, the surface (also referred to as the RP surface) onto which the reflective polarizer is conformed has a large curvature and a large sagitta, and the lens can be relatively thick. The first mold surface of the first mold is to have an identical or similar shape as that of the RP surface. To fabricate the reflective polarizer lens using the co-mold process when the RP surface of the lens has a large sagitta, the optical film including the first material can be formed (or pre-formed), for example, thermally and/or mechanically using a form process (or preforming process) to have a curved shape. The curved shape of the preformed optical film can better match the surface profile of the RP surface of the lens (or the intended lens shape) than the non-formed optical film (e.g., the optical film without being preformed is flat). For example, the optical film is thermally formed (or thermally preformed) to have a curved shape that at least conforms partially to the surface of the lens (or the first mold surface of the first mold). The preforming process described above can reduce a mismatch between a surface profile of the first mold surface and the surface profile of the preformed optical film. Otherwise, a mismatch between the surface profile of the first mold surface and the surface profile of the non-formed optical film may be relatively large, and the optical film can be folded in the co-mold process, for example, resulting in defects in the RP lens.

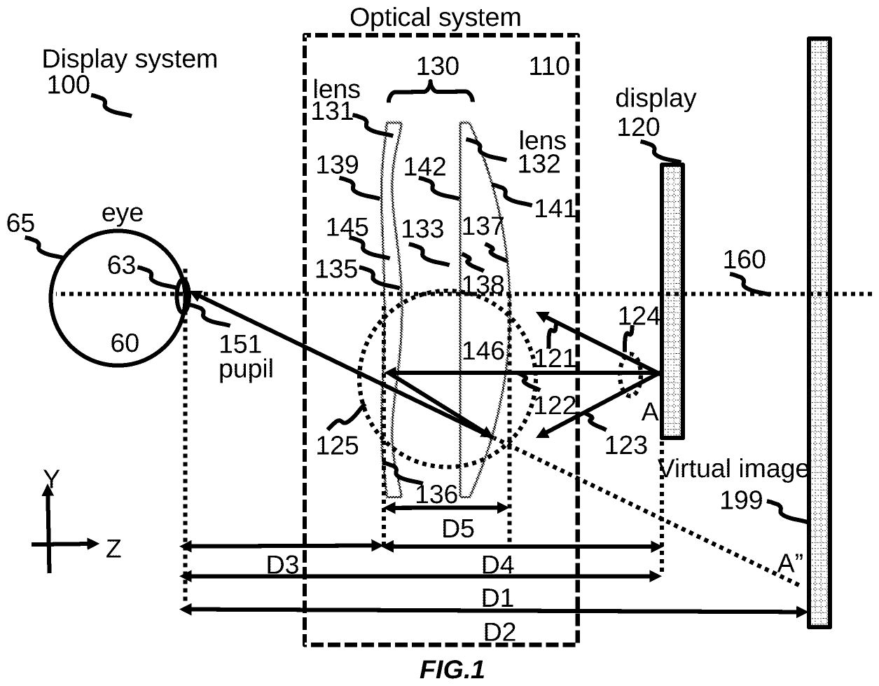

In some embodiments, the lenses of the lens system are formed by injection molding and are to satisfy certain requirements, for example, having low birefringence. To form the lenses with low birefringence with injection molding, a suitable mold flow is to be used. A suitable mold flow can be achieved without annealing, for example, when a thickness ratio of a lens is within a range, such as close to 1/1. The thickness ratio of the lens can be determined based on the smallest thickness of the lens and the largest thickness of the lens. For example, for a plano-convex lens, the thickness ratio is the ratio of the edge thickness of the lens over the center thickness of the lens, for a plano-concave lens, the thickness ratio is the ratio of the center thickness of the lens over the edge thickness of the lens, for a free-form lens, the thickness ratio is the ratio the thinnest thickness of the lens over the thickest thickness of the lens. In some examples, such as in FIG. 1, thickness ratios of the lenses in the lens system can be substantially different from 1/1 (e.g., 0.65 for a lens (131), 1/8 or a convex lens (132), and manufacturing the lens (132) can be challenging.

FIG. 1 shows a display system (e.g., a near eye display system) (100) in a side view according to some embodiments of the disclosure. The display system (100) includes an optical system (110). The optical system (110) can include a display device (120), a lens system (130), a beam splitter (BS) (141), a reflective polarizer (139), and a quarter-wave plate (QWP) (142). The display device (120) can include a pixel array configured to emit light beams and display images. The lens system (130), the beam splitter (141), the reflective polarizer (139), and the QWP (142) can direct the emitted light beams from the display device (120) to an area (151). In an example, the area (151) is located in an XY plane. In an example, the area (151) is referred to as an exit pupil of the optical system (110). The XY plane includes an X axis and the Y axis that is orthogonal to the X axis. A light receiver or detector, such as an eye (60) of a user or the like, can be located at the area (151). In an example, a lens (63) in the eye (60) forms an image on a retina (65) of the eye (60), and thus the eye (60) perceives an image on the display device (120) as a virtual image, such as a virtual image (199) in FIG. 1. The virtual image (199) appears at a distance D2 from the area (151) and appears larger than the image on the display device (120). The distance D2 is larger, and in some cases much larger, than a distance D1 between the area (151) and the display device (120).

Referring to FIG. 1, an optical cavity can be formed between the beam splitter (141) and the reflective polarizer (139). The optical cavity can include one or more lenses in the lens system (130) and the QWP (142). As described below, an optical path of a light ray (122) in a light beam is folded in the optical cavity between the beam splitter (141) and the reflective polarizer (139). Accordingly, the optical system (110) can be positioned within a distance threshold (e.g., 35 mm) of an eye of a user (e.g., the eye (60)), and the display system (100) can be referred to as an NED system. For example, the display system (100) is an HMD system worn by a user.

In example, the lens system (130) may include one or more additional lenses. For example, the lens system (130) includes a second lens (132). The second lens (132) can include an optically transparent member (146) having two opposite surfaces (137)-(138). The first lens (131) and the second lens (132) can be separated with a gap (133). In an example, the gap (133) is larger than 0. The second lens (132) can have circular symmetry around the optical axis (160). The shape of the first lens (131), the second lens (132), and other lenses can be fabricated to fix the allowable space of the HMD device. (e.g. the lens may have a truncated area to accommodate the user's facial features, e.g., user's nose).

The surfaces (135)-(138) can have any suitable shapes or surface curvatures, such as planar shape(s) parallel to the XY plane, spheric shape(s) with any suitable radius of curvature, aspheric shape(s), or other shape(s). Shapes of the surfaces (135)-(138) can be determined based on design parameters, such as focal lengths, aberration requirements, lens thicknesses, and the like. The first lens (131) can be a aspheric-aspheric lens, for example, the surface (138) is planar and the surface (137) is spheric, such as shown in FIG. 1. In the example shown in FIG. 1, the reflective polarizer (139) is disposed onto the surface (136).

The second lens (132) can be a spheric-spheric lens, a plano-spheric lens, an aspheric-spheric lens, a plano-aspheric lens, or the like. The second lens (132) can be referred to as a BS lens. In the example shown in FIG. 1, the BS (141) is disposed onto the surface (137).

The optically transparent members (145)-(146) can include any suitable material(s) including but not limited to glass (e.g., borosilicate glass, dense flint glass), polymer, plastic material(s), such as poly (methyl methacrylate) (PMMA), polyimide, acrylic, styrene, cyclic olefin polymer, cyclic olefin co-polymer, polycarbonate, and/or the like. A glass lens can be fabricated by grinding and polishing, a glass molding method, and/or the like. A polymer or plastic lens can be fabricated by diamond turning, polishing, injection molding, casting, and/or the like.

In an example, material(s) or a composition of the material(s) in the optically transparent member (145) are different from material(s) or a composition of the material(s) in the optically transparent member (146) such that the first chromatic aberration of the first lens (131) is complementary to the second chromatic aberration of the second lens (132).

In some embodiments, a lens (e.g., the first lens (131), the second lens (132) is to have low birefringence, is made with injection molding. To form the lens with low birefringence, a suitable mold flow or a good mold flow (e.g., a relatively smooth mold flow) is to be used. A suitable mold flow can be achieved without annealing, for example, when a thickness ratio of a lens is within a range, such as close to 1/1. In an example, the thickness ratio of the lens is defined as (i) a ratio of the smallest thickness of the lens over the largest thickness of the lens or (ii) a ratio of the largest thickness of the lens over the smallest thickness of the lens.

The first lens (131) can be formed by injection molding using material(s), such as polycarbonate and poly (methyl methacrylate). The first lens (131) is to have low birefringence. The good mold flow (e.g., the relatively smooth mold flow) can be achieved without annealing, for example, if a thickness ratio of the first lens 131 (e.g., a ratio of the thickness of the thinnest area of the first lens (131) over the thickness of the thickest area of the first lens 131 is within a first range R1. In an example, R1 can be less than 1, such as from 1/3 to 1/1. Referring to FIG. 1, if the thickness ratio of the first lens (131) is relatively small (e.g., 1/10) and is outside the range R1, for example, the thickness ratio of 1/10 may be too small for an injection molded lens to have low birefringence.

The display system (100) can be a component in an artificial reality system. The artificial reality system can adjust reality in some manner into artificial reality and then present the artificial reality to a user. The artificial reality can include, e.g., a virtual reality (VR), an augmented reality (AR), a mixed reality (MR), a hybrid reality, or some combination and/or derivatives thereof. Artificial reality content may include completely generated content or generated content combined with captured (e.g., real world) content. The artificial reality content may include video, audio, haptic feedback, or some combination thereof, and any of which can be presented in a single channel or in multiple channels (such as stereo video that produces a three-dimensional effect to the user). In some examples, the display system (100) can be applied to playback of live or prerecorded video.

In an embodiment, a “near eye” display system can include an optical system (e.g., including one or more optical elements) that is placed within the distance threshold of an eye of a user when the NED system (100) (e.g., an HMD, or smart glasses) is utilized. Referring to FIG. 1, the distance D1 between the display device (120) and the area (151) can be less than or equal to the distance threshold. In an example, the distance D1 is between the display device (120) and the eye (60).

The display system (100) can be a NED system implemented in various forms, such as an HMD system, smart glasses, a smart phone, and/or the like. In some examples, the artificial reality system is implemented as a standalone NED system. In some examples, the artificial reality system is implemented as a NED system connected to a host computer system, such as a server device, a console device, and the like.

The display device (120) can include a pixel array. In some examples, the pixel array includes multiple pixels arranged to form a two-dimensional surface. The two-dimensional surface of the display device (120) can be substantially flat or planar, can be curved, or can include a combination of flat and planar panels. The display device (120) can be a display panel. The display device (120) can include any suitable type(s) of display panel(s), such as a liquid crystal display (LCD) panel(s), an organic light emitting diode (OLED) panel(s), and/or the like. A resolution of the display device (120) can be defined according to pixels in the two dimensions or one of the two dimensions of the two-dimensional surface. Each pixel in the pixel array can generate a light beam. Each light beam can include a bundle of light rays in any suitable direction. For example, a pixel A on the display device (120) emits a light beam including a bundle of light rays in suitable directions. A subset (124) of the light rays in the light beam can be directed by the lens system (130) to the area (151). An angular span of the subset (124) of the light beam can be determined based on an acceptance angle ω of the lens system (130). Three light rays (121)-(123) of the subset (124) of the light beam are shown in FIG. 1. The three light rays (121)-(123) can include two boundary rays (121) and (123) and a center ray (122).

In general, a light beam is randomly polarized if the light beam includes a rapidly varying succession of different polarization states. A light beam can be polarized, such as linearly polarized (e.g., in a linear polarization state), circularly polarized (e.g., in a circular polarization state), elliptically polarized (e.g., in an elliptical polarization state), or the like. For the linearly polarized light, an electric field vector of the light beam is along a particular line. For the circularly polarized light, an electric field vector of the light beam rotates, e.g., clockwise or counter-clockwise as seen by an observer toward whom the light beam is propagating.

Degree of polarization (DOP) is a quantity that indicates a portion of an electromagnetic wave (e.g., a light beam) that is polarized. A perfectly polarized wave can have a DOP of 100%, and an unpolarized wave can have a DOP of 0%. A partially polarized wave can be represented by a superposition of a polarized component and an unpolarized component, and thus can have a DOP between 0 and 100%. DOP can be calculated as a fraction of a total power that is carried by the polarized component of the wave (e.g., a light beam).

A light beam (e.g., the light beam generated from each pixel) can have any suitable polarization state(s) or DOP. In an example, the light beam is circularly polarized having a DOP of 100%. In an example, the light beam is predominantly circularly polarized having a relatively large DOP that is above a threshold (e.g., 80% or above), such as a superposition of (i) a circularly polarized component and (ii) an unpolarized component and/or another polarization component. A circularly polarized light beam having a DOP of 100% or a predominantly circularly polarized light beam having a relatively large DOP can be referred to as a circularly polarized light beam below. In an example, a light beam is linearly polarized having a DOP of 100% or predominantly linearly polarized having a relatively large DOP that is above a threshold. A linearly polarized light beam having a DOP of 100% or a predominantly linearly polarized light beam having a relatively large DOP can be referred to as a linearly polarized light beam below.

According to an embodiment of the disclosure, the light beams generated by the display device (120) can be circularly polarized or linearly polarized.

The lens system (130) can be configured to modify the light beams generated by the display device (120), and direct the modified light beams to the area (151). In some embodiments, the lens system (130) can include diffractive elements (gratings and prisms), refractive elements (lenses), guiding elements (e.g., planar waveguides and/or fibers), and polarizing elements (e.g., polarizers, half-wave plates, quarter-wave plates, polarization rotators, Pancharatnam-Berry (PB) Phase lens, and the like). In the example shown in FIG. 1, the lens system (130) includes the first lens (131) and the second lens (132).

The first lens (131) can be disposed between the display device (120) and the area (151). The second lens (132) can be disposed between the first lens (131) and the display device (120). In an example, the first lens (131) can be referred to as an eye lens according to a proximity to the area (151) (e.g., the eye (60)), and the second lens (132) can be referred to as a display lens according to a proximity to the display device (120).

The beam splitter (141) and the reflective polarizer (139) can be disposed between the area (151) and the display device (120). The quarter-wave plate (142) can be disposed between the beam splitter (141) and the reflective polarizer (139), such as over the surface (138). Anti-reflection (AR) coating(s) can be applied to any suitable surface(s) of the lens system (130) to reduce unwanted reflections of the light beams.

The beam splitter (141) can be configured to partially transmit and partially reflect light beams incident onto the beam splitter (141). The beam splitter (141) can have an average optical transmittance T and an average optical reflectance R. In an example, a sum of T and R is 1 (i.e., 100%) over a wavelength range (e.g., 380 to 780 nanometers (nm)). The average optical transmittance T and the average optical reflectance R of the beam splitter (141) can be referred to as T/R. T or R can be in a range (e.g., from 40% to 60%). In an example, the beam splitter (141) has T/R of 40/60, 50/50, or 60/40. For example, if T and R are 50%, the beam splitter (141) transmits 50% and reflects 50% of the light beams incident onto the beam splitter (141). In general, a beam splitter can include one or more thin films coated or deposited on a surface of a lens in the lens system (130). The beam splitter (141) can include one or more thin films coated or deposited, for example, on the surface (138) of the third lens (132). The beam splitter (141) partially transmits and partially reflects light beams from the display device (120).

A polarization state of a light beam can be altered as the light beam passes through certain optical elements. In an embodiment, a polarization state of a light beam can be altered by a waveplate or a retarder as the light beam travels through the waveplate. The quarter-wave plate (142) can alter a polarization state of a light beam traveling through the quarter-wave plate (142) by 90° or π/2. In an example, the quarter-wave plate (142) converts linearly polarized light into circularly polarized light or circularly polarized light into linearly polarized light. The quarter-wave plate (142) can be formed on a surface in the lens system (130).

The reflective polarizer (139) can be configured to pass through a light beam having a first linear polarization state and reflect the light beam having a second linear polarization state. The second linear polarization state is orthogonal to the first linear polarization state. The reflective polarizer (139) can include one or more layers of optical films. In an example, the reflective polarizer (139) is formed on a surface in the lens system (130.

Referring to FIG. 1, the beam splitter (141), the quarter-wave plate (142), and the reflective polarizer (139) can conform to shapes of respective surfaces. For example, the beam splitter (141) and the quarter-wave plate (142) are curved or planar to conform to shapes of the surfaces (137) and (138), respectively. The reflective polarizer (139) is curved to conform to a shape of the surface (136).

Referring to FIG. 1, the beam splitter (141) is disposed on the surface (137) of the second lens (132), and the reflective polarizer (139) is disposed on the surface (136) of the first lens (131). The quarter-wave plate (142) is formed on the surface (138) of the second lens (132). The optical cavity can be formed between the beam splitter (141) and the reflective polarizer (139). The optical cavity can include the first lens (131), the gap (133), and the QWP (142).

The light beams emitted from the display device (120) can pass the second lens (132) and can be partially transmitted by the beam splitter (141). Subsequently, the light beams pass the optical cavity a plurality of times. In an example, the light beams pass the optical cavity for the first time and are reflected by the reflective polarizer (139). The light beams then pass the optical cavity for a second time and are partially reflected by the beam splitter (141). After passing the optical cavity for a third time, the light beams are transmitted by the reflective polarizer (139) and reach the area (151).

The optical system (110) includes a catadioptric optical system. For example, the catadioptric optical system (110) includes (i) refractive optical components (e.g., the lens system (130)) and (ii) reflective optical components (e.g., the beam splitter (141) when acting as a reflector to reflect light and the reflective polarizer (139) when acting as a reflector to reflect light).

The catadioptric optical system (110) may include a polarized catadioptric optical system. For example, each time the light beams pass through the QWP (142), a polarization state of the light beams is manipulated by the QWP (142). Accordingly, the light beams are in one polarization state and is reflected by the reflective polarizer (139) after the first pass, and the light beams are in another polarization state and is transmitted by the reflective polarizer (139) after passing the optical cavity for a third time.

The optical system (110) may be referred to as a folded optical system. As light beams are reflected between the beam splitter (141) and the reflective polarizer (139), and travel multiple times (e.g., three times) in the optical cavity, an optical path between the display device (120) and the area (151) includes a folded path (125) between the beam splitter (141) and the reflective polarizer (139). The folding of the optical path can allow the distance D1 to be decreased, and the display system (100) including the optical system (110) can be used as a NED system. In an example, the lens system (130) is designed to have a relatively small thickness D5, and may be referred to as a pancake lens system.

Referring to FIG. 1, the ray (122) emitted from the pixel A of the display device (120) passes the second lens (132) and is partially transmitted by the beam splitter (141). Subsequently, the ray (122) passes the optical cavity for a first time where the ray (122) sequentially passes through the gap (133), the QWP (142), the optically transparent member (146), and the optically transparent member (145).

After the ray (122) passes the optical cavity for the first time, the ray (122) is reflected back into the optical cavity by the reflective polarizer (139). Subsequently, the ray (122) passes the optical cavity for a second time where the ray (122) sequentially passes through the optically transparent member (145), the optically transparent member (146), the QWP (142), and the gap (133).

After the ray (122) passes the optical cavity for the second time, the ray (122) is partially reflected back into the optical cavity by the beam splitter (141). Subsequently, the ray (122) passes the optical cavity for a third time where the ray (122) sequentially passes through the gap (133), the QWP (142), the optically transparent member (146), and the optically transparent member (145). Then, the ray (122) is transmitted by the reflective polarizer (139) and travels to the area (151). In an example, the ray (122) is focused by the lens (63) of the eye (60) onto the retina (65), and the eye (60) perceives the ray (122) as if the ray (122) is from a virtual point A″ on the virtual image (199).

The light beams emitted from the pixels (e.g., including the pixel A) in the display device (120) can be circularly polarized, for example, in a first circular polarization state. The beam splitter (141) partially transmits the ray (122) in the first circular polarization state. Then the ray (122) passes the optical cavity for the first time as described above. During the first pass, the first circular polarization state of the ray (122) is converted to the second linear polarization state by the QWP (142). The second linear polarization state is along a block direction of the reflective polarizer (139). The block direction of the reflective polarizer (139) refers to a direction where if an electric field vector of a light beam is along the block direction, the light beam is blocked by the reflective polarizer (139) and is not transmitted through the reflective polarizer (139). The reflective polarizer (139) reflects the ray (122) having the second linear polarization state, for example, with a relatively high average reflectance that is above or equal to a value (e.g., 90%) over a wavelength range (e.g., 380 to 780 nm). Then the ray (122) passes the optical cavity for the second time as described above, and the ray (122) is partially reflected by the beam splitter (141). Subsequently, the ray (122) passes the optical cavity for the third time as described above. During both the second pass and the third pass, the QWP (142) alters the polarization state of the ray (122). Accordingly, the second linear polarization state of the ray (122) is converted to the first linear polarization state that is parallel to a transmission direction of the reflective polarizer (139). Thus, the reflective polarizer (139) transmits the ray (122) having the first linear polarization state such that the ray (122) is directed to the area (151) with a relatively high transmittance that is above or equal to a value (e.g., 90%) over a wavelength range (e.g., 380 to 780 nm).

Referring to FIG. 1, the optical path includes the folded path (125) between the reflective polarizer (139) and the beam splitter (141) due to the polarization change.

To achieve high-quality imaging, the reflective polarizer (139) is to have high-quality, such as a high reflectance (e.g., the high average reflectance) in the block direction, a high transmittance (e.g., the high average transmittance) in the pass direction, relatively small surface roughness, and the like. The amount of reflection in the pass direction can reflect into the optical cavity and result in ghost images. The amount of transmittance in the block direction can also result in ghost images. Further, the AR coating can be applied to any suitable surface(s) in the optical system (110) to reduce or eliminate ghosting due to the multi-reflections at various interfaces.

Polarized catadioptric optical systems are emerging solutions for virtual reality HMDs. A good VR optical system can include a large pupil volume (also referred to as an eye box) to accommodate multiple interpupillary distances and to allow for eye rotation as the user scans across the FOV. In an example, the eye box indicates a volume where an eye receives an acceptable view of an image. A size and a location of the eye box can be related to a number of constraints, such as a FOV and image quality. In an example, the eye box indicates a range of eye positions, at an eye relief distance, from which an image produced by the optical system (110) is visible. The eye box can include eye movements, such as eye rotation and/or lateral movement.

An optical power can indicate a degree to which an optical system or an optical component (e.g., a lens or a curved mirror) converges or diverges light. In an example, the optical power of the optical component or system is equal to a reciprocal of a focal length f of the optical component or system. A higher optical power indicates (i) a stronger focusing power for a converging optical component/system or (ii) a stronger diverging power for a diverging optical component/system.

In a polarized catadioptric optical system, such as the optical system (110), a folded optical path (e.g., the folded path (125)) can be used to achieve a relatively high optical power with a compact form factor. In the example shown in FIG. 1, the beam splitter (141) is a curved mirror that partially reflects and partially transmits light, and the reflective polarizer (139) can reflect as a planar mirror or transmit light depending on a polarization state of the light. Design freedoms available in a folded optical system (e.g., the optical system (110)) can provide benefits to HMD systems. The benefits can include a high resolution achieved with reflective imaging, a wide FOV (e.g., by using low aberration lenses), a compact size, a decreased weight, an ability to adjust focus, and forming a larger eye box. The FOV can indicate an extent of an observable world that is seen or detected by a light receiver (also referred to as an optical sensor). In an example, the FOV is indicated by a solid angle within which the light detector can detect or receive light. The optical system (110) shown in FIG. 1 can be manufactured by controlling a curved form and surface finish of the first lens (131). A pancake optical system (e.g., the optical system (110)) can deliver a comfortable and immersive user experience.

The optical system (110) can have a large pupil volume to accommodate multiple interpupillary distances and to allow for eye rotation as a user scans across the FOV. An interpupillary distance (IPD) is a distance between centers of pupils of eyes of a user. IPDs can vary with respect to age, gender, or the like. The optical system (110) can be designed by taking IPD variance into account such that the optical system (110) can accommodate various users with different IPDs. In an example, IPDs vary from approximately 50 to 80 mm.

In an example, to allow users to enjoy VR without prescription glasses or with a dynamic focus, the optical system (110) can adjust a diopter of a lenses in the lens system (130) to match the prescription. In an example, the diopter indicates a virtual object distance. Increasing the diopter can make an object appear closer. The focus accommodation can be achieved by changing an optical power of the optical system. The optical power of a folded mirror cavity (e.g., the optical cavity between the beam splitter (141) and the reflective polarizer (139)) can be changed by varying a cavity length (or a gap) relative to a reference cavity length corresponding to a reference optical power.

The display system (100) can include other suitable mechanical, electrical and optical components. For example, the display system (100) includes a frame (101) that can protect other components of the display system (100). In another example, the display system (100) can include a strap (not shown) to fit the display system (100) on a user's head. In another example, the display system (100) can include communication components (not shown, e.g., communication software and hardware) to wirelessly communicate with a network, a host device, and/or other device. In some examples, the display system (100) can include a light combiner that can combine the virtual content and see-through real environment.

Considering human factors, such as human vision (e.g., a FOV of a human eye, eye rotation), head rotation, and the like may help design optical parameters of the optical system (110). An optical design with a high resolution over a range of eye rotations can make a viewing experience of a user more natural.

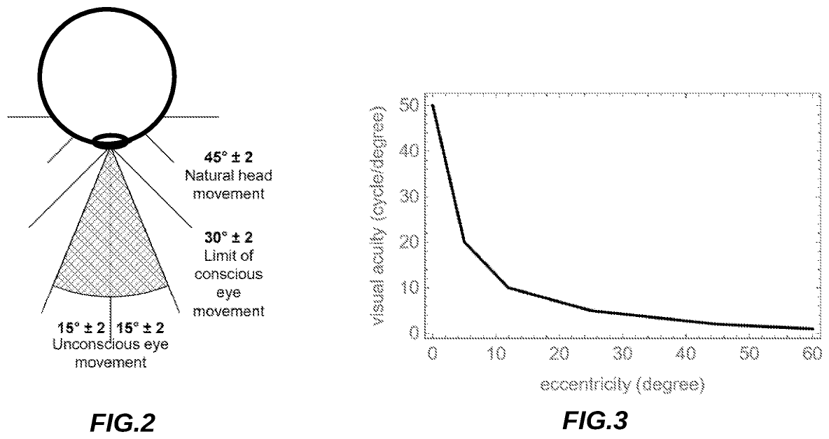

Unconstrained or unconscious eye rotation can be less than 20°. FIG. 2 shows examples of eye rotations and head rotations. A horizontal unconscious eye rotation can be less than a value (e.g.,) 20° from a center to a left side or a right side, such as 15°+2°. A horizontal conscious eye rotation can be larger than that of the horizontal unconscious eye rotation. In an example, the horizontal conscious eye rotation is up to a value, such as 30°+2°. In another example, an eye can rotate approximately 28°±8° up, and 47°±8° down. FIG. 2 also shows an example of a natural head movement. In an example, the natural head movement is 45°±2° horizontally.

In an example, humans have a slightly over 210° forward-facing horizontal arc of visual fields without eye movements. A horizontal FOV of both human eyes can be 210°. A vertical range of the visual field (or the vertical FOV) in humans is around 150°.

A human eye is not a perfect lens over a large FOV. Visual acuity can indicate clarity or sharpness of vision. An eccentricity can refer to an angular distance from a center of a visual field or from the foveola of a retina. FIG. 3 shows a relationship between visual acuity (including peripheral visual acuity) and eccentricity. The visual acuity can decrease with the eccentricity. Accordingly, a resolution of an optical system in a peripheral field can be lower than a resolution of the optical system in a center field because eyes lack visual acuity in the peripheral field without eye rotation to gaze directly to the peripheral field. Considering visual acuity can avoid overdesign of an optical system.

In some examples, parameters of the display system (100) include a field of view (FOV), an eye relief, a lens track length, a display size, a size of the area (151), and/or the like. The eye relief (e.g., a distance D3) can refer to a distance between a light receiver (e.g., the area (151)) and the lens system (130). In an example, the distance D3 between the area (151) and the last optical component (e.g., the first lens (131)) in the optical system (110) before the area (151) is 15 mm. The lens track length (e.g., a distance D4) can refer to a distance between the display device (120) and the lens system (130). The distance D4 between the display device (120) and the first lens (131) is 23 mm. In the schematic shown in FIG. 1, the distance D4 is measured from the display device (120) to the surface (136). In an example, D1 is equal to a sum of D3 and D4. In another example, the distance D4 is measured from the display device (120) to the surface (137). The display size is indicated by a display image circle that is imaged by the optical system (110) onto the area (151), and the display image circle has a radius of 27 mm. The size (e.g., pupil size) of the area (151) is 5 mm. The FOV of the optical system (110) is 100°. The optical system (110) can form the virtual image (199) from an image on the display device (120) for a suitable range of polychromatic wavelengths, such as in the visible wavelengths (e.g., 380 to 780 nm with a 400 nm), polychromatic wavelengths near green color (e.g., 500 to 540 nm with a 40 nm bandwidth), or the like. The parameter values provided in the description are merely exemplary and are not intended to limit the scope of the disclosure.

In an embodiment, the beam splitter (BS) includes a first field region having a first reflectance, and a second field region having a second reflectance wherein the said second reflectance is higher than the said first reflectance. Having the variable reflectance beam splitter may help to improve the energy efficiency of the display system. Referring to FIG. 1, the ray (122) emitted from the pixels in the display device (120), passes the optical cavity between the beam splitter (141) and the reflective polarizer (139) for the three-time as described above. At first, the ray (122) with an intensity I will transmit through a BS area 1 having transmittance T1, then it will reflect from a BS area 2 having reflectance R2, and then it will enter the pupil area (151). The intensity of ray (122) at pupil area (151) will be I*(T1)*(R2). For a 50% BS, the reflectance and transmittance can be equally 50%, the intensity of ray (122) is I*(50%)*(50%) or I*(25%), or only the efficiency of the ray path is 25%. In the case that the ray (122) is emitted from the center of the display, or at a normalized field location of height equal 0, the ray (122) will travel near the optical axis (160) of the display system, through the BS area 1 and reflected from BS area 2 and the BS area 1 and the BS area 2 are likely the same area or the two areas are in proximity to each other, then, R2=100%−T2, and T1=T2 for lossless BS, or the maximum efficiency is (50%)*(50%)=25%. In the case that ray (122) is emitted from the edge of the display, or at a normalized field location of height equal to 1, the ray (122) will travel through the BS area 1 and reflect from BS area 2, and the BS area 1 and the BS area 2 are likely not the same area or the two areas are not in proximity to each other, and if BS area 2 only has to reflect, but not to transmit any ray emitted from the display, the reflectance R2 can be 100%, and BS area 1 has dual duties to reflect and transmit any ray emitted from the display, the transmittance T1 can be 50%, or the maximum efficiency is (100%)*(50%)=50%. Thus, by allowing the beam splitter (BS) to have a first field region having a first reflectance, a second field region having a second reflectance, and the second field region not have dual transmitting, and reflecting duties or only have reflecting duty, or have more reflecting duty than transmitting duty, then the second reflectance can be higher than the first reflectance, and improving overall the efficiency of the display system. However, since the efficiency of such a system utilizing the variable reflectance BS varies spatially, the display intensity will also need to vary spatially to provide perceivable uniform image intensity to the user's eyes.

Examples of display systems according to some embodiment of the disclosure are modeled using Zemax OpticStudio® software.

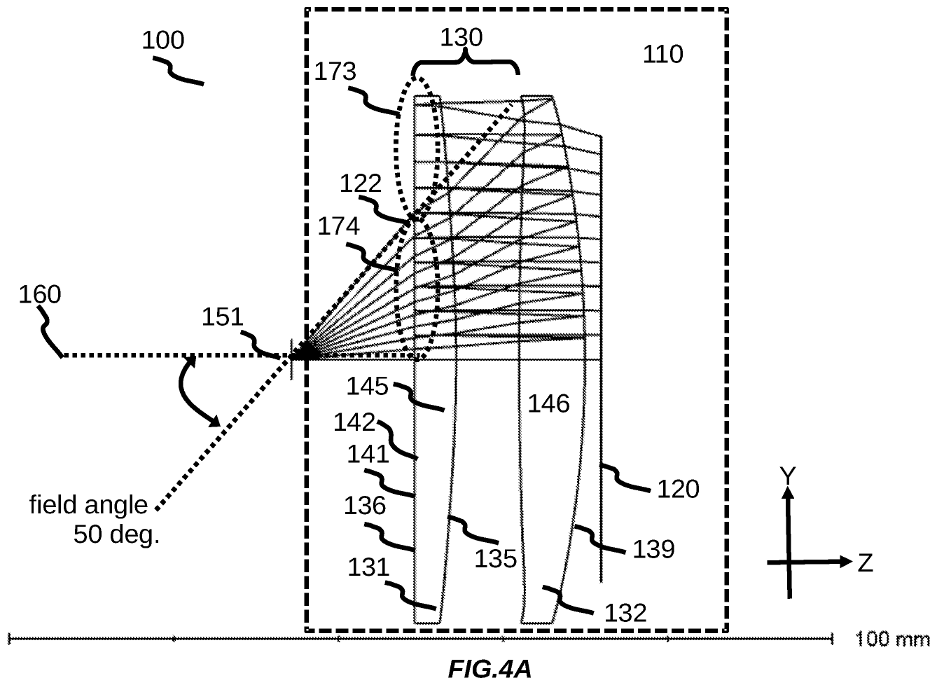

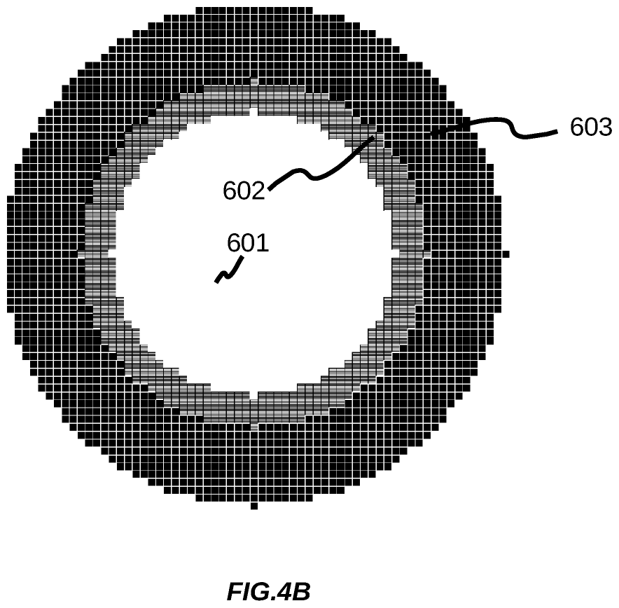

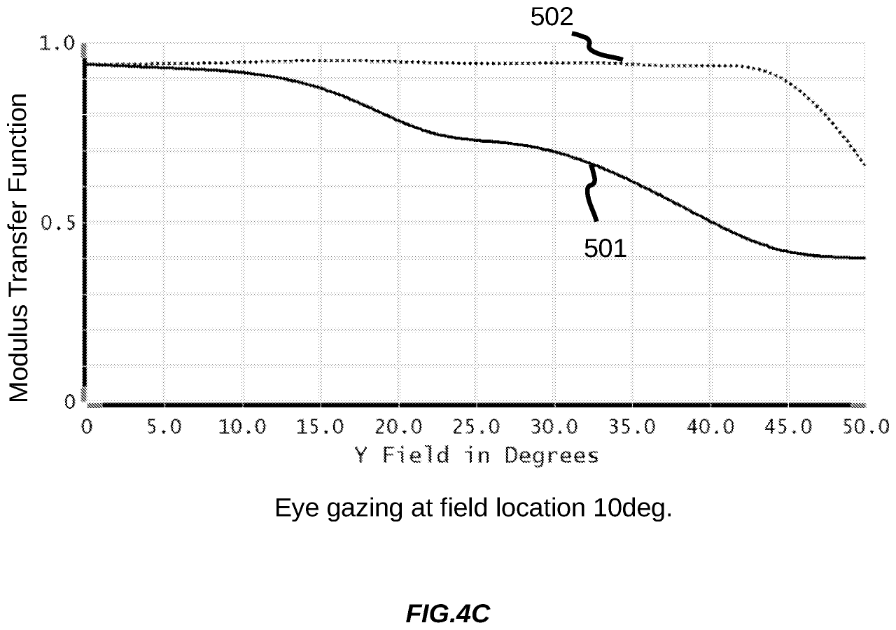

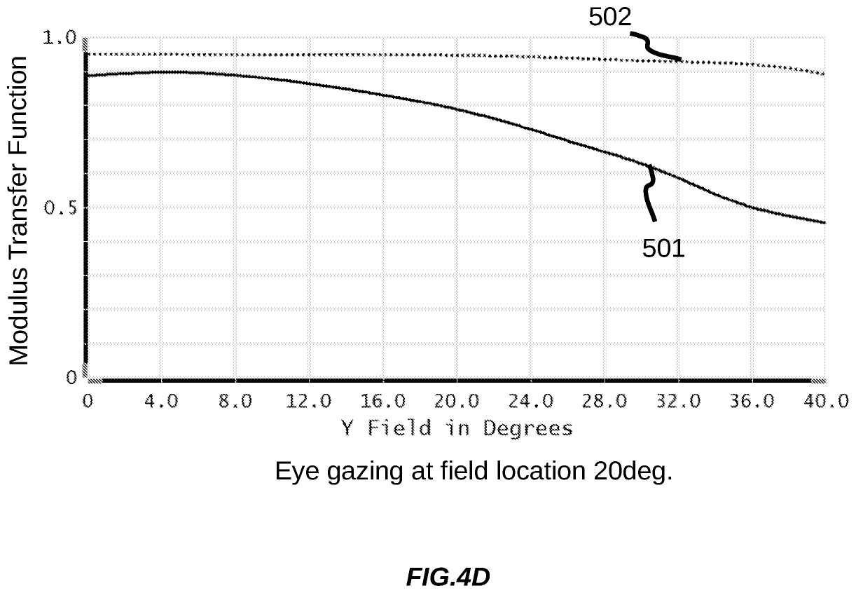

FIG. 4A shows an example of a display system (e.g., a near-eye display system) (100) in a side view according to some embodiment of the disclosure. The display system (100) includes an optical system (110). The optical system (110) can include a display device (120), a lens system (130), a beam splitter (BS) (141), a reflective polarizer (139), and a quarter-wave plate (QWP) (142). The display device (120) can include a pixel array configured to emit light beams and display images. The lens system (130), the beam splitter (141), the reflective polarizer (139), and the QWP (142) can direct the emitted light beams from the display device (120) to an area (151). In this example, the area (151) is located in an XY plane. In an example, the area (151) is referred to as an exit pupil of the optical system (110). The eye relief (e.g., a distance D3) can refer to the distance between a light receiver (e.g., the area (151)) and the lens system (130). In this example, the distance D3 between the area (151) and the last optical component (e.g., the first lens (131)) in the optical system (110) before the area (151) is 15 mm. The lens track length (e.g., a distance D4) can refer to the distance between the display device (120) and the lens system (130). The distance D4 between the display device (120) and the first lens (131) is 23 mm. The display size is indicated by a display image circle that is imaged by the optical system (110) onto the area (151), and the display image circle has a radius of 27 mm. The size (e.g., pupil size) of the area (151) is 5 mm. The FOV of the optical system (110) is 1000. The virtual image (199) appears at a distance of D2 from the area (151) and appears larger than the image on the display device (120). In this example, the virtual image distance is 2 meters. The optical system (110) can form the virtual image (199) from an image on the display device (120) for a suitable range of polychromatic wavelengths, such as in the visible wavelengths (e.g., 380 to 780 nm with a 400 nm), polychromatic wavelengths near green color (e.g., 500 to 540 nm with a 40 nm bandwidth), or the like. The parameter values provided in the description are merely exemplary and are not intended to limit the scope of the disclosure.

FIG. 4A shows an example of a display system (e.g., a near-eye display system) (100) in a side view according to some embodiment of the disclosure. The light beams emitted from the pixels in the display device (120) can be linearly polarized, for example, in a first linear polarization state. Then the ray (122) passes the optical cavity between the beam splitter (141) and the reflective polarizer (139) for the three-time as described above. During the first, second pass and third pass, the QWP (142) alters the polarization state of the ray (122). The ray (122) passes the optical cavity for the third time as described above. The optical cavity comprises both the optically transparent member (146), and the optically transparent member (145). Accordingly, the linear polarization state of the ray (122) emitted from the display (120) is configured to the first linear polarization state that is parallel to the transmission direction of the reflective polarizer (139). Thus, the reflective polarizer (139) transmits the ray (122) having the first linear polarization state into the optical cavity (as in optical cavity (125) in FIG. 1)). Inside of optical cavity, the ray (122) will pass through QWP (142) and convert to the first circular polarization state. The ray (122) can pass through BS (141) and exit the cavity with the first circular polarization state, which will be blocked by a clean-up polarizer to be described later. The ray (122) will reflect from BS (141) and pass through QWP (142) again and convert to the second linear polarization state. The polarization state of ray (122) is orthogonal to the transmission direction of RP (139) or parallel to the reflection direction of RP (139) and will reflect from RP (139) and pass through QWP (142) and convert to the second circular polarizer state and pass through from BS (141) toward the pupil area (151). Not shown in FIG. 4A, there is a clean-up circular polarizer position between pupil area (151) and BS (141), the duty of this clean-up circular polarizer is to pass the (122) with the second circular polarizer state exiting from the cavity, but also to block the (122) with the first second circular polarizer state exiting from the cavity. The clean-up circular polarizer can be constructed with a linear polarizer and a QWP. Due to complexity of the ray path, the QWP used in construction of the clean-up circular polarizer can be the same or different to the QWP (142).

In this example shown in FIG. 4A, the beam splitter (141) and waveplate (142) are positioned on surface (136) wherein waveplate (142) is sandwiched between the BS (141) and the RP (139). The beam splitter comprise two field region, a first field region (174) and a second field region (173). The ray (122) entering the pupil area (151) is configured to have field angle of 50 deg. As described earlier, the FOV of the optical system (110) is 100 deg or the maximum field angle is limited to 50 deg. The ray (122) with a field angle of 50 deg will enter pupil area (151) after exiting the BS (141) at a location of a radius R of about 18 mm to center of the first lens. The first field region is configured as an area inside a R-mm radius of the first lens center, and the second field region is configured as an area outside a R-mm radius of the first lens center. Referring to FIG. 4A, the first field region (174) of the BS has to transmit and to reflect ray, therefore it is best to figure as a BS region having a reflectance of 50% and a transmittance of 50%, the second field region (173) of the BS has to reflect ray (more than to transmit ray), therefore it is best to figure as a BS region having a reflectance of higher than 50% up to 100%. In this example, the second field region (173) has duty to reflect rays for the image field locations of 30 deg to 50 deg, and the first field region (174) has duty to reflect and transmit for the image field locations of 0 deg to 30 deg. Having a second field region to reflect and not to transmit rays for more image field location would help to improve the lens system efficiency.

FIG. 4B shows an example of beam splitter design for an optical system example shown in FIG. 4A. BS has three field regions: the first field region (601), the second field region (603), and the third field region (602). The first field region (601) is a circle area of radius 18 mm which the aperture of the lens system for the FOV of 100 deg (referring to FIG. 4A, the ray (122) with a field angle of 50 deg will enter the pupil area (151) after exiting the BS (141) at a location of a radius R of about 18 mm to the center of the first lens). The second field region (602) is the annulus area with an inner radius of 22 mm and an outer radius of 32 mm, which is the radius of the first lens (131) as shown in FIG. 4A. The third field region (602) is a region between the first field region and the second field region. The first field region is shown as a uniform white BS area having transmittance and reflection of 50%. The second field region is shown as a non-uniform black/white mesh pattern where the white pattern area has a transmittance and reflectance of 50%, and the black mesh pattern has a reflectance of more than 90% and transmittance of less than 10%, and white and black pattern area are about 19% and 81% of the whole area, or the black area has the black feature of 0.9 mm×0.9 mm in 1 mm×1 mm black/white unit cell. So the overall reflectance of the second field region is about 80%. The reflectance of the third field region is about 65%. The BS can be fabricated with two thin film coatings. The first coating can be a uniform silver alloy thin film coating onto QWP film to achieve 50% transmission and reflection. The second coating can be a thicker thin film aluminum coating over the first coating via a shadow mask which has zero opening over the first field and 81% opening over the second field region.

In this example shown in FIG. 4A, the optical cavity comprises both the optically transparent member (146) and the optically transparent member (145). It is important to control the polarization of the ray (122) through the system including the optical cavity. The birefringence of optical transparent member (145) and (146) cause polarization leakages, strayed light, and ghost in the system. In this example, a transparent member (146) is made of COC to ensure low birefringence, and a transparent member (145) is made of COC. Transparent member (145) is an injection molded lens made of a cyclic olefin polymer (COP) or cyclic olefin copolymer (COC). The molded lens with COP or COC resin may result in lower birefringence relative to a molded lens with PMMA resin. Molding process and mold flow design could help to control the birefringence characteristics of a molded lens. Typically, retardation of transparent members (145) and (146) is preferably lower than 10 nm, preferably lower than 5 nm, and preferably lower than 2 nm.

FIG. 4C shows an MTF of the optical system (110) shown in FIG. 4A. In an example, the eye (60) is positioned at the area (151) with a gaze off-axis at the image field location of 10 deg. (e.g., the viewing angle or eye rotation is 100). FIG. 4C shows a tangential MTF (501) and a sagittal MTF (502) versus a field angle (e.g., a Y field from 00 to 400) at a resolution of 10 lp/mm (or 10 cycles/mm). MTF is modeled with a poly-chromatic wavelength range of 520-560 nm for a bandwidth of 40 nm.

FIG. 4D shows an MTF of the optical system (110) shown in FIG. 4A. In an example, the eye (60) is positioned at the area (151) with a gaze off-axis at the image field location of 20 deg. (e.g., the viewing angle or eye rotation is 200). FIG. 4D shows a tangential MTF (501) and a sagittal MTF (502) versus a field angle (e.g., a Y field from 00 to 400) at a resolution of 10 lp/mm (or 10 cycles/mm). MTF is modeled with a poly-chromatic wavelength range of 520-560 nm for a bandwidth of 40 nm.

In an embodiment, the beam splitter (BS) includes a first BS area having a first transmittance, and a second BS area having a second transmittance wherein the said first transmittance is higher than the said second transmittance. Having the variable reflectance and transmittance beam splitter may help to improve the energy efficiency of the display system. Referring to the FIG. 1, At first, the ray (122) originated from a pixel of the display with the intensity I will transmit through a BS area 1 having transmittance T1, then it will reflect from a BS area 2 having reflectance R2, and then it will enter the pupil area (151). The intensity of ray (122) at pupil area (151) will be I*(T1)*(R2). In the case that the BS is a mesh pattern that has about 50% opening area with a transmittance of 100% and the remaining area with a reflection of 100%, so overall the transmission or reflection of the mesh pattern is 50%. In the case of the display pixel unit cell size is 14 um×14 μm, the active pixel area is 10 um×10 μm, and the unit cell of the BS mesh is also 14 um×14 um where the opening area is 10 um×10 um. If the active pixel area is adjacent and positioned in alignment with the opening area of BS mesh, the ray (122) originated from a pixel of the display with the intensity I will transmit through a BS opening area having a transmittance of 100%, then it will reflect from a BS having a reflectance of 50%, and then it will enter the pupil area (151). The intensity of ray (122) at pupil area (151) will be I*(100%)*(50%) or efficiency is 50%. If the pixel is aligned with the opening area of the BS mesh but is not adjacent, then efficiency drops back to 25%. Relaying the image plane of the display to the BS plane by relay optics, e.g., using microlens array optics, may help to improve display system efficiency. Having the display with collimated beam output, and having collimated beam output angle matching with the chief ray angle of the optical lens and display system design will also help to improve display system efficiency.

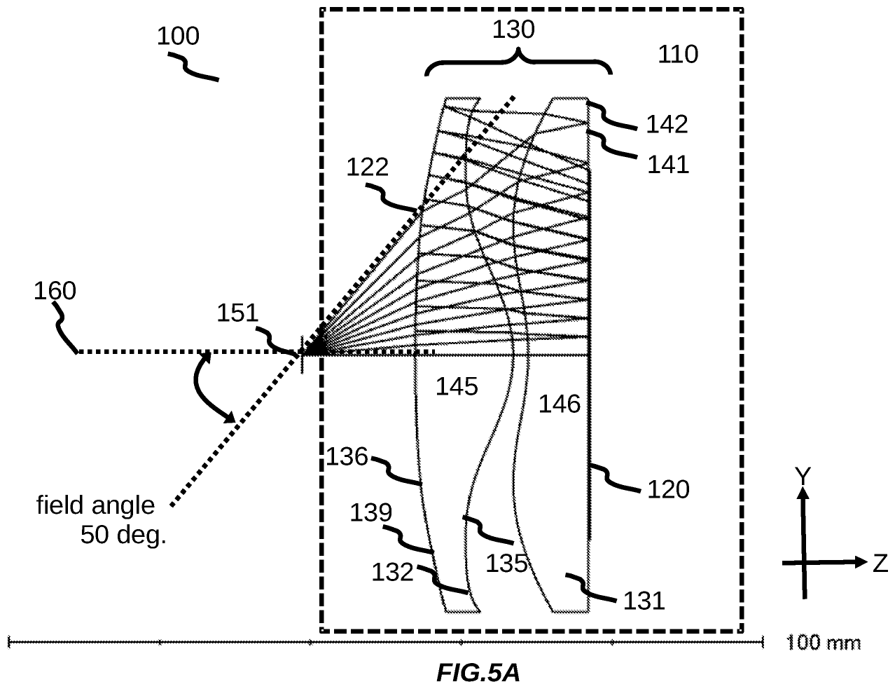

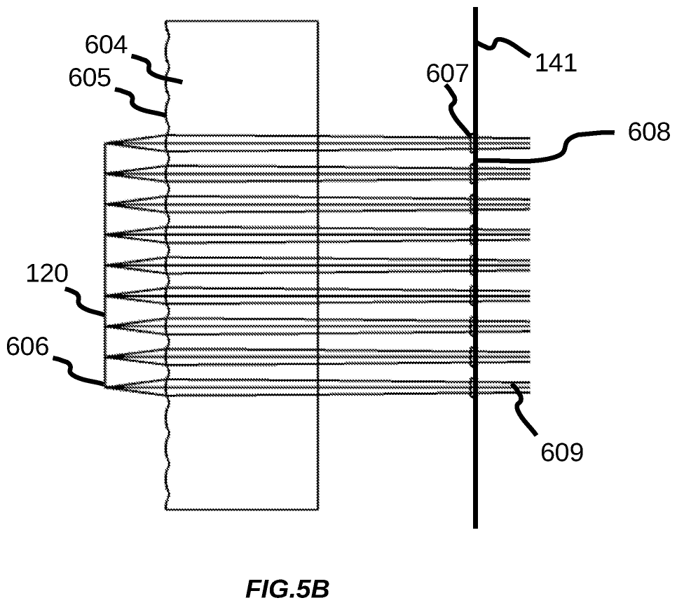

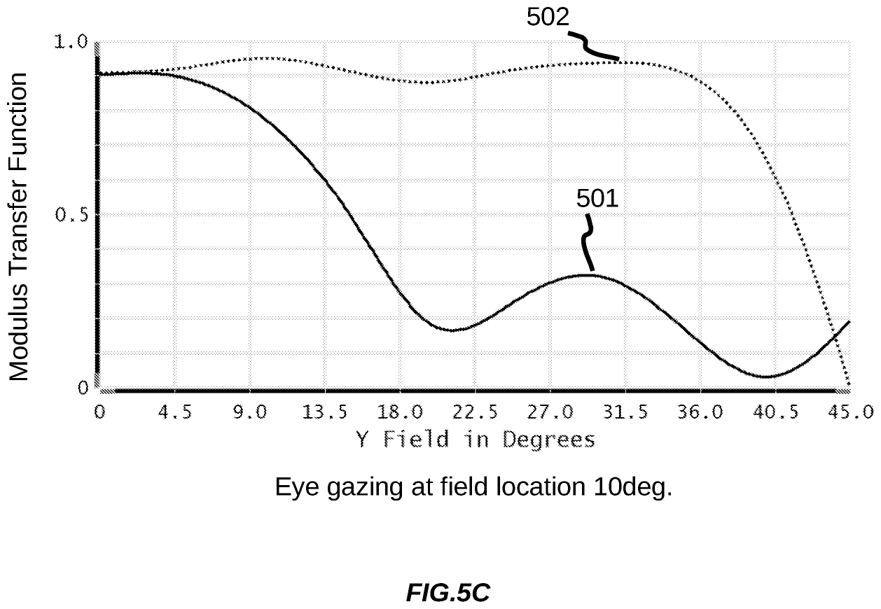

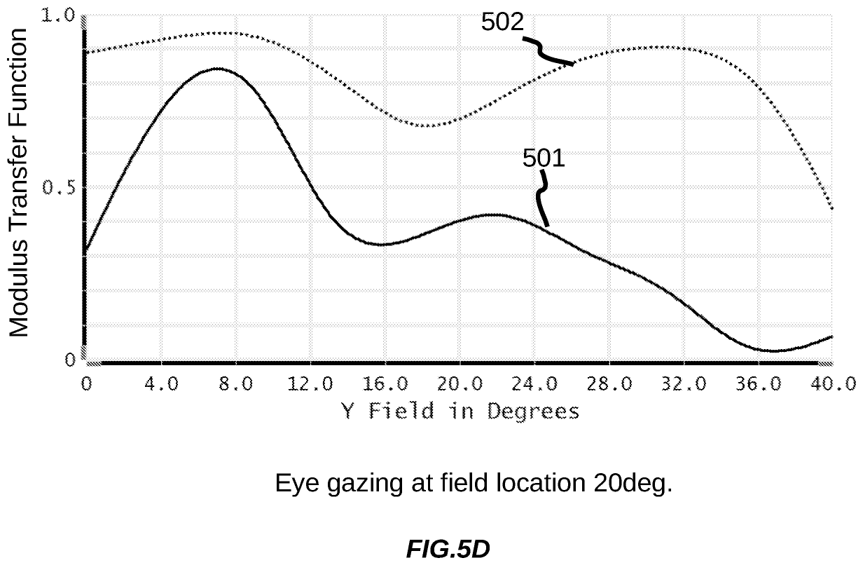

FIG. 5A shows an example of a display system (e.g., a near-eye display system) (100) in a side view according to some embodiment of the disclosure. The display system (100) includes an optical system (110). The optical system (110) can include a display device (120), a lens system (130), a beam splitter (BS) (141), a reflective polarizer (139), and a quarter-wave plate (QWP) (142). The display device (120) can include a pixel array configured to emit light beams and display images. The lens system (130), the beam splitter (141), the reflective polarizer (139), and the QWP (142) can direct the emitted light beams from the display device (120) to an area (151). In this example, the area (151) is located in an XY plane. In an example, the area (151) is referred to as an exit pupil of the optical system (110). The eye relief (e.g., a distance D3) can refer to the distance between a light receiver (e.g., the area (151)) and the lens system (130). In this example, the distance D3 between the area (151) and the last optical component (e.g., the second lens (132)) in the optical system (110) before the area (151) is 15 mm. The lens track length (e.g., a distance of D4) can refer to the distance between the display device (120) and the lens system (130). The distance D4 between the display device (120) and the second lens (132) is 24 mm. The display size is indicated by a display image circle that is imaged by the optical system (110) onto the area (151), and the display image circle has a radius of 24.5 mm. The size (e.g., pupil size) of the area (151) is 5 mm. The FOV of the optical system (110) is 1000. The virtual image (199) appears at a distance of D2 from the area (151) and appears larger than the image on the display device (120). In this example, the virtual image distance is 2 meters. The optical system (110) can form the virtual image (199) from an image on the display device (120) for a suitable range of polychromatic wavelengths, such as in the visible wavelengths (e.g., 380 to 780 nm with a 400 nm), polychromatic wavelengths near green color (e.g., 500 to 540 nm with a 40 nm bandwidth), or the like. The parameter values provided in the description are merely exemplary and are not intended to limit the scope of the disclosure.

FIG. 5A shows an example of a display system (e.g., a near-eye display system) (100) in a side view according to some embodiment of the disclosure. The light beams emitted from the pixels in the display device (120) can be circularly polarized, for example, in a first circular polarization state. Then the ray (122) passes the optical cavity between the beam splitter (141) and the reflective polarizer (139) for the three-time as described above. During the first, second pass and third pass, the QWP (142) alters the polarization state of the ray (122). The ray (122) passes the optical cavity for the third time as described above. The optical cavity comprises both the optically transparent member (146) and the optically transparent member (145). Accordingly, the linear polarization state of the ray (122) emitted from the display (120) is configured to the first circular polarization state. The ray (122) will pass the BS (141) to enter the optical cavity. Inside of optical cavity, the ray (122) will pass through QWP (142) and convert to the first polarization state. The ray (122) will reflect the reflective polarizer (139) and pass through QWP (142) again and convert to the second circular polarization state. The ray (122) will reflect from BS (141) and pass through QWP (142) again and convert to the second linear polarization state which is parallel to the transmission direction of RP (139). The ray (122) will pass the RP (139) and enter the pupil area (151).

FIG. 5B shows an example of beam splitter design for an optical system example shown in FIG. 5A. The beam splitter (141) is a reflective mesh structure comprising a mesh cell unit, where the mesh cell unit has a mesh opening area (607) and a mesh frame area (608). The display (120) has a pixel (606) with a pixel pitch (or a spacing between pixels). The mesh cell unit size (with height) is on the order of the display pixel pitch. The mesh opening area has higher transmittance and lower reflectance than those of the mesh frame area. The composition of the mesh cell unit cell helps to configure the reflection and transmission of the BS (141). For the mesh opening area having 10% transmittance, mesh frame area having 90% reflectance, and a mesh cell unit which 50% of its area is the mesh opening area, and 50% of its area is the mesh frame area, then the BS will have 50% transmittance and reflectance. Light emitted from a pixel (606) from the display can be collimated to become a collimated beam (609) by a micro-lens array (604) having a micro-lens array surface (605) facing the display and will pass through the mesh opening. Micro-lens array (604) can be designed to collimate the emitted light beam from the display and output the collimated beam at an angle to match the chief ray angle required by the optical design shown in FIG. 5A. BS (141) is designed to have each mesh opening area at the center of the output beam from each pixel from the display. The BS can be fabricated using a lithographic method, for example, metal BS coating is deposited on a glass wafer, followed by a masking process (e.g., patterned photoresist mask), and an etching process to provide BS mesh pattern or patterned masking layer is deposited on a glass wafer, followed the BS coating deposition and lift-up process. The BS mesh pattern can be fabricated onto the waveplate or the optical lens, or the optical transparent film. The QWP (142) can also be patterned the same as the BS mesh pattern, for example, liquid crystal-based waveplate is deposited onto optical transparent film, followed by BS coating, followed by masking and etching process to apply pattern to BS/waveplate coating. When QWP is patterned together with the BS mesh pattern, the BS mesh frame area should have a reflectance of 100%, and the BS mesh opening area has a transmittance of 100%, the polarization configuration will be different from what is described earlier.

In this example shown in FIG. 5A, the optical cavity comprises both the optically transparent member (146) and the optically transparent member (145). It is important to control the polarization of the ray (122) through the system including the optical cavity. The birefringence of optical transparent member (145) and (146) cause polarization leakages, strayed light, and ghost in the system. In this example, a transparent member (146) is made of COC to ensure low birefringence, and a transparent member (145) is made of COC. Transparent member (145) is an injection molded lens made of a cyclic olefin polymer (COP) or cyclic olefin copolymer (COC). The molded lens with COP or COC resin may result in lower birefringence relative to a molded lens with PMMA resin. Molding process and mold flow design could help to control the birefringence characteristics of a molded lens. Typically, retardation of transparent members (145) and (146) is preferably lower than 10 nm, preferably lower than 5 nm, and preferably lower than 2 nm.

FIG. 5C shows an MTF of the optical system (110) shown in FIG. 5A. In an example, the eye (60) is positioned at the area (151) with a gaze off-axis at the image field location of 10 deg. (e.g., the viewing angle or eye rotation is 100). FIG. 5C shows a tangential MTF (501) and a sagittal MTF (502) versus a field angle (e.g., a Y field from 00 to 400) at a resolution of 10 lp/mm (or 10 cycles/mm). MTF is modeled with a poly-chromatic wavelength range of 520-560 nm for a bandwidth of 40 nm.

FIG. 5D shows an MTF of the optical system (110) shown in FIG. 4A. In an example, the eye (60) is positioned at the area (151) with a gaze off-axis at the image field location of 20 deg. (e.g., the viewing angle or eye rotation is 200). FIG. 5D shows a tangential MTF (501) and a sagittal MTF (502) versus a field angle (e.g., a Y field from 00 to 400) at a resolution of 10 lp/mm (or 10 cycles/mm). MTF is modeled with a poly-chromatic wavelength range of 520-560 nm for a bandwidth of 40 nm.

A lens can include a center region and a peripheral region that surrounds the center region. The center region of the lens can be used for high-resolution and low ghost viewing/imaging, and viewing/imaging through the peripheral region of the lens can have a low resolution. A Fresnel structure (also referred to as a Fresnel lens structure or a Fresnel feature) can cause diffraction artifacts, and thus viewing and/or imaging via a region including a Fresnel structure may deteriorate the resolution. In some examples, it is less desirable to incorporate a Fresnel feature into a lens area (e.g., a center region of the lens) that is used for a high-resolution and low ghost optical (viewing/imaging) path. In various embodiments, a good optical viewing area can be within a FOV threshold, such as a 70o on-axis view. Thus, a Fresnel structure or a Fresnel feature can be included outside the FOV threshold (e.g., a FOV of 70o), for example, to ensure that the Fresnel structure only affects a low-resolution far-field peripheral vision while enhancing lens manufacturability as described above.

A computer or computer-readable medium can control various aspects of an HMD system in which a display system (e.g., (100)) including an optical system (e.g., (110) is incorporated. Various aspects of the display system including controlling movements and positioning of the optical components (e.g., the first lens (131), the second lens (132), and the display device (120) can be implemented as computer software using computer-readable instructions and physically stored in one or more computer-readable media.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

Computer system may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Computer system may also include certain human interface output devices. Such human interface output devices may be stimulating the senses of one or more human users through, for example, tactile output, sound, light, and smell/taste. Such human interface output devices may include tactile output devices (for example tactile feedback by the touch-screen, data-glove (not shown), or joystick, but there can also be tactile feedback devices that do not serve as input devices), audio output devices (such as: speakers, headphones, visual output devices (such as touch-screens to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system can also include an interface to one or more communication networks. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like. TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses networks. Certain protocols and protocol stacks can be used on each of those networks and network interfaces as described above.

As an example, and not by way of limitation, the computer system having architecture, and specifically the core can provide functionality as a result of processor(s) (including CPUs, GPUs, FPGA, accelerators, and the like) executing software embodied in one or more tangible, computer-readable media.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An optical system, comprising:
first lens including a first optically transparent member having a first surface, a second surface; a second lens including a second optically transparent member having a third surface and a fourth surface;
an optical cavity comprising a beam splitter, a reflective polarizer, a waveplate, and at least one of the said lens, wherein the said waveplate and the said optically transparent member of the said lens are positioned between the said beam splitter and the said reflective polarizer, wherein the said beam splitter, the reflective polarizer, and waveplate are disposed on and substantially conforming to the surfaces selected from the said surfaces;
wherein the said beam splitter includes a first field region having a first reflectance, and a second field region having a second reflectance and wherein the said second reflectance is at least ten percent higher than the said first reflectance.

2. The optical system according to claim 1, wherein
the said field region is configured as an area along a radial direction from a center to an edge of the said first lens;
the said first field region is configured as an area near the center of the first lens, and the said second field region is configured as an area near the edge of the first lens.

3. The optical system according to claim 2, wherein
the said first field region is configured as an area inside a 20-mm radius of the first lens center;
the said second field region is configured as an area outside a 20-mm radius of the first lens center.

4. The optical system according to claim 1, wherein
the said beam splitter is configured to partially transmit and partially reflect light beams from a display device in a predetermined wavelength range;
the said reflective polarizer is configured to pass through light having a first polarization state and reflect light having a second polarization state in a predetermined wavelength range;
the said waveplate is configured to modify the polarization state of transmitted light in a predetermined wavelength range.

5. The optical system according to claim 1, wherein
the said beam splitter does not have a uniform reflectance within the said field region.

6. The optical system according to claim 1, wherein
The said beam splitter is an optical thin film coating.

7. The optical system according to claim 5, wherein
the said beam splitter is a reflective mesh including a high reflective area and a low reflective area within the said field region.

8. The optical system according to claim 7, wherein
The said reflective mesh is a reflective mirror coating.

9. An optical system, comprising:
first lens including a first optically transparent member having a first surface, a second surface; a second lens including a second optically transparent member having a third surface and a fourth surface;
an optical cavity comprising a beam splitter, a reflective polarizer, a waveplate, and at least one of the said lens, wherein the said waveplate and the said optically transparent member of the said lens are positioned between the said beam splitter and the said reflective polarizer, wherein the said beam splitter, the reflective polarizer, and waveplate are disposed on and substantially conforming to the surfaces selected from the said surfaces;
wherein the said beam splitter includes a first beam splitter area having a first reflectance and a first transmittance, and a second beam splitter area having a second reflectance and a second transmittance and wherein the said first transmittance is at least ten percent higher than the said second transmittance.

10. The optical system according to claim 9, wherein
the optical system includes a display device having a pixel pitch and a pixel array, wherein a pixel array in the display device is configured to generate a light pixel beam and the pixel pitch is spacing from the center of a pixel to the center of the adjacent pixel;
the said beam splitter area is configured as the areas in a reflective mesh unit cell, wherein the mesh unit cell consist of the said first beam splitter area and the said second beam splitter area, wherein the dimension of the mesh unit cell is on the order of the said pixel pitch.

11. The optical system according to claim 10, wherein
the said first beam splitter area is configured as an area less than an area of 70 micron×70 micron;
the said mesh unit cell is configured as an area less than an area of 100 micron×100 micron.

12. The optical system according to claim 10, wherein
the said first beam splitter area is configured at about the center of the said light pixel beam.

13. The optical system according to claim 9, wherein
the said beam splitter is a patterned optical thin film coating.

14. The optical system according to claim 9, wherein
the said beam splitter is a patterned reflective mirror coating.

15. The optical system according to claim 9, wherein
the said beam splitter is configured to partially transmit and partially reflect light beams from a display device in a predetermined wavelength range;
the said reflective polarizer is configured to pass through light having a first polarization state and reflect light having a second polarization state in a predetermined wavelength range;
the said waveplate is configured to modify the polarization state of transmitted light in a predetermined wavelength range.

16. The optical system according to claim 10, wherein
the optical system includes a micro-lens array.

17. The optical system according to claim 10, wherein
the said waveplate is a patterned waveplate.

18. The optical system according to claim 1, wherein
the said optical transparent member selected from the said transparent member is made of a plastic material.

19. The optical system according to claim 18, wherein
the said plastic material is selected from a plastic material group including polycarbonate, polymethyl methacrylate, polystyrene, cyclic olefin copolymer, cycloolefin polymer material.

20. The optical system according to claim 1, wherein
the said reflective polarizer has higher transmittance for the wavelength range 800-1000 nm than transmittance for the wavelength range 400-800 nm.
